(19) United States
(12) Patent Application Publication
(10) Pub. No.: US 2012/0136890 A1
(43) Pub. Date: May 31, 2012

(54) BEHAVIOR PATTERN RECOGNITION METHOD, SYSTEM AND COMPUTER APPLICATION PROGRAM THEREOF

(76) Inventors: Yung-Chuan WEN, Taipei City (TW); Min-Siong Liang, Taoyuan County (TW)

(21) Appl. No.: 12/969,254

(22) Filed: Dec. 15, 2010

(30) Foreign Application Priority Data
Nov. 26, 2010 (TW) 099141005

(51) Int. Cl. G06F 17/30

(52) U.S. Cl. 707/769; 707/E17.039

(57) ABSTRACT

A behavior pattern recognition method, system and a computer application program thereof are presented. The method is applicable to an electronic device which has a storage unit for storing multiple sets of behavior record information, and the method includes the following step. Firstly, a first detecting unit acquires first behavior feature information, a collaboration network module acquires at least one second detecting unit having coherence with the first detecting unit. Then, the at least one second detecting unit acquires at least one second behavior feature information, and a processing unit compares the at least one second behavior feature information and the behavior record information to generate at least one comparison result. Finally, a behavior definition represented by the first behavior feature information is determined according to the comparison result.

### CROSS-REFERENCE TO RELATED APPLICATION

This application claims the benefit of Taiwan Patent Application No. 099141005, filed on Nov. 26, 2010, which is hereby incorporated by reference for all purposes as if fully set forth herein.

### BACKGROUND OF THE INVENTION

1. Field of Invention

The present invention relates to a behavior pattern recognition method, system and a computer application program thereof, and more particularly to a behavior pattern recognition method and system using sensor information and behavior feature information of relevant persons to deduce a user's behavior and a computer application program thereof.

2. Related Art

Due to the quick progress of technology, the processing of events becomes more complicated. In accord with the changes, the management of human, event, environmental, and object resources gradually changes from the manual supervision inspection into the automated management and control.

In the office or business areas, the manual management and control is one of the most important parts. Since each person has a different identity, level, authority and nature of work, the region that can be reached by the person in the office or business area differs. In a common manner, multiple monitors are disposed at different spots in a building to send back the captured image frame to a control center at any time, and display devices disposed in the control center switch the frames at a specific time or play the frames of several monitors at the same time for the management staff to observe if there are persons without authorization enter the spots under surveillance.

However, although this surveillance method does not need to arrange a guard at the spot under control, this surveillance method still needs manpower dedicated to observe, and in practice, oversights inevitably occur. Therefore, there is a need for a means which is more effective and capable of automatically informing the abnormal situations properly.

### SUMMARY OF THE INVENTION

The present invention is directed to a behavior pattern recognition method, system and a computer application program thereof, thereby providing the convenience for a person to manage and control.

The present invention provides a behavior pattern recognition method, which is applicable to an electronic device having a storage unit for storing multiple sets of behavior record information, and the method comprises the following steps. Firstly, a first detecting unit acquires first behavior feature information and a collaboration network module acquires at least one second detecting unit having coherence with the first detecting unit. Then, at least one second detecting unit acquires at least one second behavior feature information and a processing unit compares at least one second behavior feature information and the behavior record information to generate at least one comparison result. Finally, a behavior definition represented by the first behavior feature information is determined according to the comparison result.

In an embodiment of the present invention, before the step of acquiring at least one second detecting unit having coherence with the first detecting unit by the collaboration network module, a plurality of detecting units acquires a plurality of sample behavior information and analyzes the sample behavior information to generate behavior record information.

In an embodiment of the present invention, the method further comprises comparing coherence of the detecting units and the first detecting unit; and screening out the detecting units having the coherence with the first detecting unit exceeding a preset value to serve as at least one second detecting unit according to the coherence.

In an embodiment of the present invention, the method further comprises disposing a behavior analysis module to analyze sample behavior information to generate a plurality of behavior record information.

In an embodiment of the present invention, the first detecting unit and the second detecting unit are non-invasive detectors, and each comprise an electrical detector, a sound sensor, an infrared sensor, a video/audio recorder, an electromagnetic sensor, and a mobile phone having detecting and sensing functions.

In an embodiment of the present invention, the method further comprises the following steps. First behavior feature information and at least one second behavior feature information are acquired respectively by the first detecting unit and the at least one second detecting unit according to a preset time interval.

The present invention provides a behavior pattern recognition system, which comprises a storage unit, a first detecting unit, at least one second detecting unit, and a processing unit. The storage unit stores multiple sets of behavior record information and the first detecting unit acquires first behavior feature information. At least one second detecting unit has coherence with the first detecting unit and acquires at least one second behavior feature information. The processing unit compares at least one second behavior feature information and the behavior record information to generate at least one comparison result, and determines a behavior definition represented by the first behavior feature information according to the comparison result.

In an embodiment of the present invention, the system further comprises a plurality of detecting units to acquire a plurality of sample behavior information.

In an embodiment of the present invention, the system further comprises a behavior analysis module for analyzing the sample behavior information to generate a plurality of behavior record information.

In an embodiment of the present invention, the system further comprises a collaboration network module for acquiring at least one second detecting unit having coherence with the first detecting unit.

In an embodiment of the present invention, the first detecting unit and the second detecting unit are non-invasive detectors. The non-invasive detector comprises an electrical detector, a sound sensor, an infrared sensor, a video/audio recorder, an electromagnetic sensor, and a mobile phone having detecting and sensing functions.

In an embodiment of the present invention, a time interval is preset in the first detecting unit and the first behavior feature information is acquired according to the time interval.

In an embodiment of the present invention, a time interval is preset in the at least one second detecting unit and at least one second behavior feature information is acquired according to the time interval.

In an embodiment of the present invention, the coherence of the first detecting unit and at least one second detecting unit includes position information.

The present invention further provides a computer program product, which is provided for an electronic equipment to execute the above behavior pattern recognition method, the process flow is as described above, and the details will not be repeated herein again.

The present invention adopts a group interaction structure and utilizes a feature capturing method and a machine learning method in cooperation with the group interaction model to deduce the user behavior, thereby acquiring a more accurate user behavior, such that the overall recognition rate is greatly improved.

### BRIEF DESCRIPTION OF THE DRAWINGS

The present invention will become more fully understood from the detailed description given herein below for illustration only, and thus are not limitative of the present invention, and wherein:

FIG. 1 is a flow chart of steps of a behavior pattern recognition method according to the present invention;

FIG. 2 is a flow chart of steps of behavior pattern recognition method and preparation works thereof according to the present invention;

FIG. 3 is a schematic block diagram of elements of a behavior pattern recognition system according to the present invention; and

FIG. 4 is a schematic view of a behavior pattern recognition system according to another embodiment of the present invention.

### DETAILED DESCRIPTION OF THE INVENTION

Hereinafter, the details of the embodiments of the present invention will be illustrated with reference to the drawings to make features and advantages of the present invention more comprehensible.

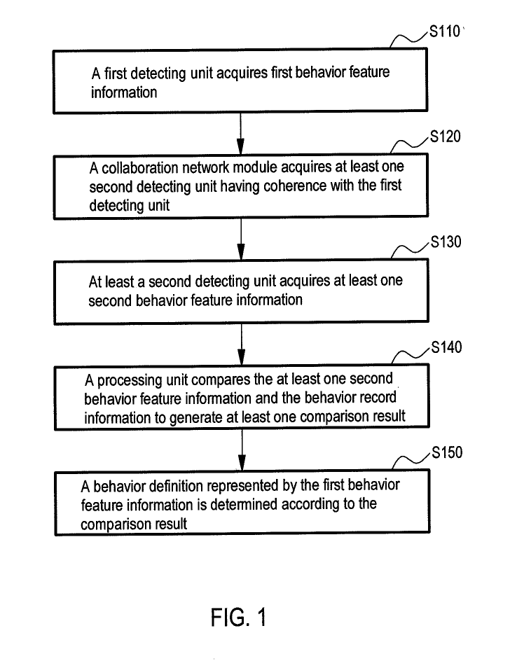

FIG. 1 is a flow chart of steps of a behavior pattern recognition method according to the present invention. The present invention provides a behavior pattern recognition method, which is applicable to an electronic device having a storage unit for storing multiple sets of behavior record information. The method includes the following step.

In Step S110, firstly, a first detecting unit acquires first behavior feature information.

In this embodiment, a plurality of detecting units must be used to acquire a plurality of sample behavior information and analyze the sample behavior information to generate behavior record information. Coherence of the detecting unit and the first detecting unit is compared, the detecting units having the coherence with the first detecting unit exceeding a preset value are screened out to serve as the at least one second detecting unit according to the coherence.

In this embodiment, the method further includes disposing a behavior analysis module to analyze the sample behavior information to generate a plurality of behavior record information.

In Step S120, a collaboration network module acquires at least one second detecting unit having coherence with the first detecting unit.

In this embodiment, the first detecting unit and the second detecting unit are non-invasive detectors, and the non-invasive detector includes an electrical detector, a sound sensor, an infrared sensor, a video/audio recorder, an electromagnetic sensor, and a mobile phone having detecting and sensing functions.

In Step S130, the at least one second detecting unit acquires at least one second behavior feature information.

In this embodiment, the first behavior feature information and the at least one second behavior feature information are acquired respectively by the first detecting unit and the at least one second detecting unit according to a preset time interval.

In Step S140, a processing unit compares the at least one second behavior feature information and the behavior record information to generate at least one comparison result.

In Step S150, a behavior definition represented by the first behavior feature information is determined according to the comparison result.

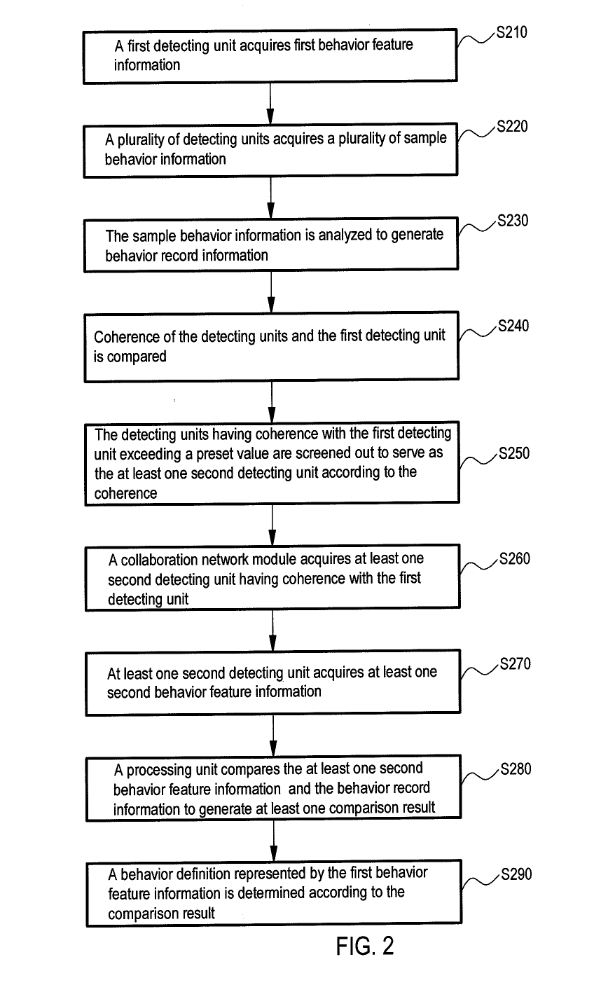

FIG. 2 is a flow chart of steps of a behavior pattern recognition method according to the present invention and preparation works thereof. The method includes the following steps.

In Step S210, a first detecting unit acquires first behavior feature information.

In Step S220, a plurality of detecting units acquires a plurality of sample behavior information.

In Step S230, the sample behavior information is analyzed to generate behavior record information.

In Step S240, coherence of the detecting units and the first detecting unit is compared.

In Step S250, the detecting units having coherence with the first detecting unit exceeding a preset value are screened out to serve as the at least one second detecting unit according to the coherence.

In Step S260, a collaboration network module acquires at least one second detecting unit having coherence with the first detecting unit.

In Step S270, at least one second detecting unit acquires at least one second behavior feature information.

In Step S280, a processing unit compares the at least one second behavior feature information and the behavior record information to generate at least one comparison result.

In Step S290, a behavior definition represented by the first behavior feature information is determined according to the comparison result.

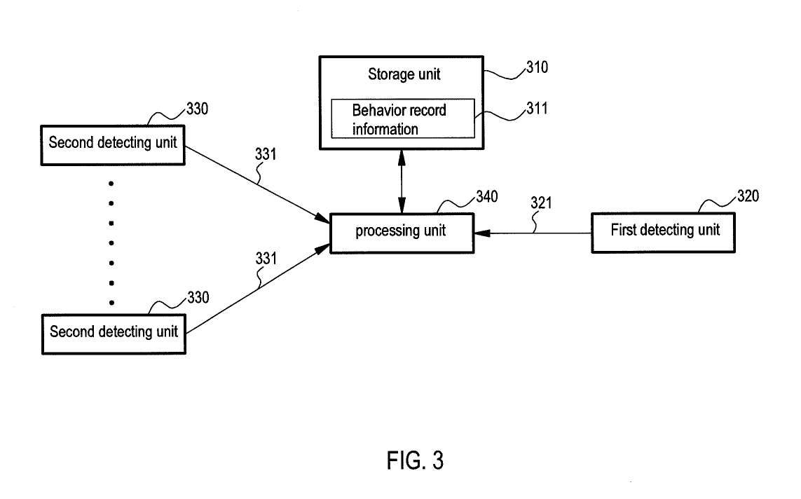

FIG. 3 is a schematic block diagram of elements of a behavior pattern recognition system according to the present invention. In this figure, a behavior pattern recognition system of the present invention is shown, which includes a storage unit 310, a first detecting unit 320, at least one second detecting unit 330, and a processing unit 340. The storage unit 310 stores multiple sets of behavior record information 311, and the first detecting unit 320 acquire first behavior feature information 321. The at least one second detecting unit 330 has coherence with the first detecting unit 320, and acquires at least one second behavior feature information 331. The processing unit 340 compares the at least one second behavior feature information 331 with the behavior record information 311 to generate at least one comparison result, and a behavior definition represented by the first behavior feature information 321 is determined according to the comparison result.

In this embodiment, the system further includes a plurality of detecting units to acquire a plurality of sample behavior information.

In this embodiment, the system further includes a behavior analysis module to analyze the sample behavior information to generate a plurality of behavior record information.

In this embodiment, the system further includes a collaboration network module to acquire at least one second detecting unit having coherence with the first detecting unit.

In this embodiment, the first detecting unit and the second detecting unit are non-invasive detectors. The non-invasive detector includes an electrical detector, a sound sensor, an infrared sensor, a video/audio recorder, an electromagnetic sensor, and a mobile phone having detecting and sensing functions.

In this embodiment, a time interval is preset in the first detecting unit and the first behavior feature information is acquired according to the time interval.

In this embodiment, a time interval is preset in the at least one second detecting unit and at least one second behavior feature information is acquired according to the time interval.

In this embodiment, the coherence of the first detecting unit and at least one second detecting unit includes position information, for example, at the position of an office or a classroom.

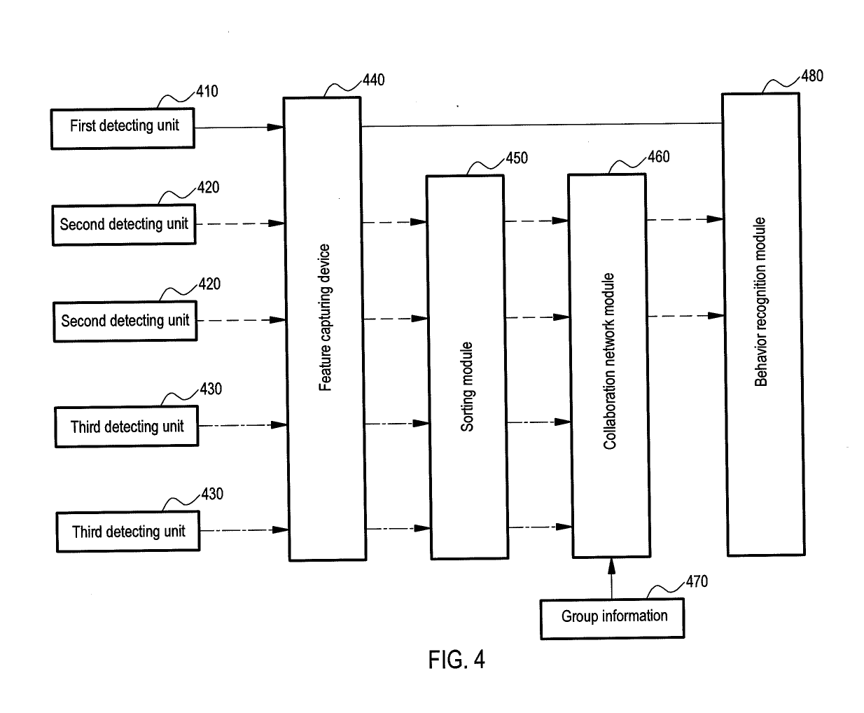

FIG. 4 is a schematic view of a behavior pattern recognition system according to another embodiment of the present invention. In this embodiment, a first detecting unit 410 detects the behavior feature information of the user, and firstly the behavior feature information of the first detecting unit 410, a second detecting unit 420 and a third detecting unit 430 are input to a feature capturing device 440. For the ease of illustration, the second detecting unit 420 is preset to be other users coherent to the user.

In this embodiment, the feature capturing device 440 captures feature by observation, and different sensors may be applicable to different feature capturing methods, but the binary signals like PIR or Reed Switch do not need this method.

Then, the behavior feature information of the second detecting unit 420 and the third detecting unit 430 passes through the feature capturing device 440 and is input in a sorting module 450 and a collaboration network module 460. In this embodiment, the sorting module 450 mainly identifies status of other users, such as at work, leave the seat, and off work.

Group information 470 is added in the collaboration network module 460 to screen out the behavior feature information of the second detecting unit 420 and the third detecting unit 430. Then, the collaboration network inputs the user behavior feature information of the second detecting unit 420 related to the user of the first detecting unit 410 to a behavior recognition module 480, thereby determining a behavior definition represented by the user behavior feature information of the first detecting unit 410.

In this embodiment, the user status values of the first detecting unit 410 and the second detecting unit 420 are taken as the input values, and the output values are the user behavior, such as, at the seat (operating the computer), at the seat (other behaviors), leaving the seat (at the meeting inside), leaving the seat (at the meeting outside), leaving the seat (others), or off work.

In summary, the present invention adopts a group interaction structure and utilizes a feature capturing method and a machine learning method in cooperation with the group interaction model to deduce the user behavior, and thus the present invention may be schemed in the following fields.

(1) The features of the present invention may be used to assist the enterprises or consultancy companies to clearly know the social network status and the working status of the staff, thereby providing a solution for the enterprises, improving the working efficiency, the innovation of the enterprises and the working satisfaction. Different from collecting the poll, the working status of the staff are more clearly, so suggestion and assistance may be made to those having a low working efficiency.

(2) In regard with the aged care, the family members of a senior may know the living status of the senior by using this system, and this system may record detailed living behaviors and can also be used to identify the health conditions of the senior.

(3) In regard with the surveillance on the behaviors of the kindergarten children, the parents may know the child's behaviors and the activities of the child by using this system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A behavior pattern recognition method, applicable to an electronic device having a storage unit for storing multiple sets of behavior record information, comprising:
acquiring first behavior feature information by a first detecting unit;
acquiring at least one second detecting unit having coherence with the first detecting unit by a collaboration network module;
acquiring at least one second behavior feature information by at least one second detecting unit;
comparing the at least one second behavior feature information with the behavior record information by a processing unit to generate at least one comparison result; and
determining a behavior definition represented by the first behavior feature information according to the comparison result.

2. The behavior pattern recognition method according to claim 1, wherein before the step of acquiring at least one second detecting unit having coherence with the first detecting unit by the collaboration network module, the method further comprises:
acquiring a plurality of sample behavior information by a plurality of detecting units; and
analyzing the sample behavior information to generate the behavior record information.

3. The behavior pattern recognition method according to claim 2, further comprising:
comparing coherence of the detecting units with the first detecting unit; and
screening out the detecting units having coherence with the first detecting unit exceeding a preset value to serve as the at least one second detecting unit according to the coherence.

4. The behavior pattern recognition method according to claim 2, further comprising disposing a behavior analysis module to analyze the sample behavior information to generate a plurality of behavior record information.

5. The behavior pattern recognition method according to claim 1, wherein the first detecting unit and the second detecting unit are non-invasive detectors.

6. The behavior pattern recognition method according to claim 5, wherein the non-invasive detector comprises an electrical detector, a sound sensor, an infrared sensor, a video/audio recorder, an electromagnetic sensor, and a mobile phone having detecting and sensing functions.

7. The behavior pattern recognition method according to claim 1, further comprising acquiring and storing coherence information of time and the behavior feature information, wherein the step comprises:
acquiring the first behavior feature information and the at least one second behavior feature information respectively by the first detecting unit and the at least one second detecting unit according to a preset time interval.

8. The behavior pattern recognition method according to claim 1, wherein the coherence of the first detecting unit and the at least one second detecting unit comprises position information.

9. A behavior pattern recognition system, comprising:
a storage unit, for storing multiple sets of behavior record information;
a first detecting unit, for acquiring first behavior feature information;
at least one second detecting unit, having coherence with the first detecting unit and acquiring at least one second behavior feature information; and
a processing unit, for comparing the at least one second behavior feature information and the behavior record information to generate at least one comparison result and determining a behavior definition represented by the first behavior feature information according to the comparison result.

10. The behavior pattern recognition system according to claim 9, further comprising a plurality of detecting units for acquiring a plurality of sample behavior information.

11. The behavior pattern recognition system according to claim 9, further comprising a behavior analysis module, for analyzing the sample behavior information to generate a plurality of behavior record information.

12. The behavior pattern recognition system according to claim 9, further comprising a collaboration network module, for acquiring at least one second detecting unit having coherence with the first detecting unit.

13. The behavior pattern recognition system according to claim 9, wherein the first detecting unit and the second detecting unit are non-invasive detectors.

14. The behavior pattern recognition system according to claim 13, wherein the non-invasive detector comprises an electrical detector, a sound sensor, an infrared sensor, a video/audio recorder, an electromagnetic sensor, and a mobile phone having detecting and sensing functions.

15. The behavior pattern recognition system according to claim 9, wherein a time interval is preset in the first detecting unit, and the first behavior feature information is acquired according to the time interval.

16. The behavior pattern recognition system according to claim 9, wherein a time interval is preset in the at least one second detecting unit, and the at least one second behavior feature information is acquired according to the time interval.

17. The behavior pattern recognition system according to claim 9, wherein the coherence of the first detecting unit and the at least one second detecting unit comprises position information.

18. A computer application program for behavior pattern recognition, applicable to an electronic device which carries out the behavior pattern recognition method and comprises a storage unit for storing multiple sets of behavior record information, and the method comprises:
acquiring first behavior feature information by a first detecting unit;
acquiring at least one second detecting unit having coherence with the first detecting unit by a collaboration network module;
acquiring at least one second behavior feature information by the at least one second detecting unit;
comparing the at least one second behavior feature information with the behavior record information by a processing unit to generate at least one comparison result; and
determining a behavior definition represented by the first behavior feature information according to the comparison result.
